(19) United States
(12) Patent Application Publication
(10) Pub. No.: US 2023/0169332 A1
(43) Pub. Date: Jun. 1, 2023

(54) METHOD AND SYSTEM FOR MACHINE LEARNING FROM IMBALANCED DATA WITH NOISY LABELS

(71) Applicant: NAVER CORPORATION, Gyeonggi-do (KR)

(72) Inventors: Shyamgopal Karthik, Bangalore (IN); Jérome Revaud, Meylan (FR); Boris Chidlovskii, Meylan (FR)

(73) Assignee: NAVER CORPORATION, Gyeonggi-do (KR)

(21) Appl. No.: 17/829,848

(22) Filed: Jun. 1, 2022

Related U.S. Application Data
(60) Provisional application No. 63/283,492, filed on Nov. 28, 2021.

(51) Int. Cl. G06N 3/08

(52) U.S. Cl. CPC G06N 3/08

(57) ABSTRACT

A computer-implemented method for training an artificial neural network with training data including samples and corresponding labels for performing a task includes: pre-training the artificial neural network to generate matrix representations that are invariant to a predetermined set of data augmentations applied to a sample, where the artificial neural network includes an encoder module and a projection module configured to generate the matrix representations based on ones of the samples, respectively; and after the pre-training, fine-tune training the artificial neural network using a loss function, wherein fine-tuning the artificial neural network includes adjusting, based on the labels, one or more weights of the projection module while maintaining constant weights of the encoder module, and where the loss function is based on a logit adjustment loss that is based on logits that are adjusted based on a class distribution of the training data.

### CROSS-REFERENCE TO RELATED APPLICATIONS

This application claims the benefit of U.S. Prov. App. No. 63/283,492, filed on 28 Nov. 2021. The entire disclosure of the application referenced above is incorporated herein by reference.

### FIELD

The present disclosure relates to systems and methods for machine learning and, more particularly, to systems and methods for machine learning using noisy labeled data.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Artificial intelligence may use large-scale training data to allow for supervised training. The quality of trained machine-learning methods may be dependent on the quality of the training data. Some approaches may assume that (i) data is balanced (i.e., there are equal number of samples for all categories), and (ii) all annotated labels are clean and reliable. However, it may be difficult and costly to acquire training datasets that respect these assumptions.

Approaches for mitigating the impact of not respecting these assumptions (ii) may be based on sample selection, label correction, or noise-aware losses. These approaches for addressing the problem of label noise however may rely on the assumption that data is balanced.

Approaches for effectively learning from unbalanced training data include approaches for modifying the sampling method, modifying the loss function, or performing a post-hoc correction. However, these approaches may rely on the assumption that all annotated labels are clean and reliable. As illustrated by results discussed further below, methods tailored to learn from noisy labels degrade in the presence of imbalanced training data.

Real-world datasets may have both large label noise and a large imbalance ratio. For example, the Clothing-1M dataset is estimated to have 38.5% incorrect labels and, at the same time, the most populated class includes five times more instances than the smallest class. Other examples include the landmarks dataset and the WebVision dataset which, respectively, are estimated to include 75% and 20% annotation errors and are estimated to have imbalance ratios of about 10:4 and 24, respectively.

### SUMMARY

The present application describes an approach for addressing both imbalance and label noise in training data for deep learning. According to embodiments, a computer-implemented method for training an artificial neural network with training data including data items and corresponding labels is provided. The method includes pre-training the artificial neural network to generate representations invariant under a predetermined set of data augmentations applied to a data item, where the artificial neural network includes an encoder followed by a projection head generating the representations. Generating representations that are invariant may mean that the representations are the same regardless of which one of the set of data augmentations are applied to the input sample. For example, a first representation may be generated when a first data augmentation is applied to an input sample, and a second representation may be generated when a second data augmentation (different than the first data augmentation) is applied to the input sample, where the first and second augmentations are different, and the first and second representations are approximately equal or the same. The method further includes fine-tuning the artificial neural network, where fine-tuning the artificial neural network includes adjusting, using the labels, at least a part of the weights of the projection head while freezing the weights of the encoder. A loss function employed for the fine-tuning is based on a logit adjustment loss, where the logit adjustment loss is based on logits that are adjusted based on an estimated class distribution.

According to an embodiment, the loss function allows curriculum learning by including a difference between the logit adjustment loss and a separation parameter defining an expected logit adjustment loss, includes the loss function further includes a term including an optimal per-sample confidence parameter. The logit adjustment loss may be determined by taking a softmax over logits that are adjusted based on the observed class distribution. The method may further include, before fine-tuning the artificial neural network, estimating the class distribution. The method may also include, during training, determining the separation parameter as a running average of the logit adjustment loss.

According to another aspect, the distribution of the labels over the data items is a long-tailed class distribution and the labels are noisy.

According to another aspect, the projection head includes a number of fully-connected layers, where adjusting at least a part of the weights of the projection head includes adjusting the weights of at least one of the fully-connected layers. The number of fully-connected layers may be three, and adjusting the weights of at least one of the fully-connected layers may include adjusting the weights of a middle layer of the fully-connected layers while freezing the weights of the other fully-connected layers.

According to yet another aspect, the number of fully-connected layers is two, and, when a noise level of the labels is greater than a threshold, adjusting the weights of at least one of the fully-connected layers comprises adjusting the weights of only the last fully-connected layer.

According to yet another aspect, pre-training the artificial neural network to generate representations invariant under the set of data augmentations includes optimizing a loss between respective representations generated by the artificial neural network for a first augmented data item and a second augmented data item, where the first and second augmented data items are generated by applying to the data item a respective first or second data augmentation of the set of data augmentations.

In aspects, the data items of the training data are image data items, and the data augmentations are image transformations. The artificial neural network may be fine-tuned for image classification, or fine-tuned for image regression.

According to other aspects, pre-training is based on a self-supervised learning method employing a contrastive loss for negative and positive pairs constructed from the training data, or on a self-supervised learning method employing a redundancy reduction loss.

According to another aspect, during the pre-training, outputs of the projection head are provided to a prediction head, where the artificial neural network is trained together with the prediction head to minimize a similarity loss.

According to a further aspect, one or more computer-readable storage media are provided, the computer-readable storage media having computer-executable instructions stored thereon, which, when executed by one or more processors perform one of the methods described herein.

In a feature, a computer-implemented method for training an artificial neural network with training data including samples and corresponding labels for performing a task is described and includes: pre-training the artificial neural network to generate matrix representations that are invariant to a predetermined set of data augmentations applied to a sample, where the artificial neural network includes an encoder module and a projection module configured to generate the matrix representations based on ones of the samples, respectively; and after the pre-training, fine-tune training the artificial neural network using a loss function, wherein fine-tuning the artificial neural network includes adjusting, based on the labels, one or more weights of the projection module while maintaining constant weights of the encoder module, and where the loss function is based on a logit adjustment loss that is based on logits that are adjusted based on a class distribution of the training data.

In further features, the method further includes curriculum learning based on a difference between the logit adjustment loss and a separation parameter defining an expected logit adjustment loss, where the loss function includes a term including a predetermined per-sample confidence parameter.

In further features, the method further includes determining the separation parameter as a running average of the logit adjustment loss.

In further features, the logit adjustment loss is determined based on a softmax over the logits that are adjusted based on the class distribution.

In further features, the method further includes before fine-tune training the artificial neural network, estimating the class distribution.

In further features, the class distribution of the labels over the samples is a long-tailed class distribution.

In further features, the labels are noisy.

In further features, the projection module includes two or more fully-connected layers, wherein adjusting one or more of the weights of the projection module includes adjusting one or more of the weights of at least one of the two or more fully-connected layers.

In further features, the projection module includes three fully-connected layers, and adjusting one or one or more weights of includes: adjusting one or more weights of a middle layer of the three fully-connected layers while maintaining constant weights of the other ones of the three fully-connected layers.

In further features, the projection module includes two fully-connected layers, and the method includes, when a noise level of the labels is greater than a predetermined value, adjusting one or more of the weights includes adjusting one or more of the weights of only the last one of the two fully-connected layers and maintaining constant weights of first and middle ones of the two fully-connected layers.

In further features, the pre-training includes optimizing a loss between respective representations generated by the artificial neural network for a first augmented data sample and a second augmented data sample, where the first and second augmented samples are generated by the artificial neural network by applying first and second data augmentations of the set of predetermined data augmentations, respectively, to the sample.

In further features, the samples are image samples, and wherein the data augmentations are image transformations.

In further features, the method further includes, by the artificial neural network, classifying an object in an image after the fine-tune training.

In further features, the method further includes, by the artificial neural network, performing image regression after the fine-tune training.

In further features, the pre-training includes self-supervised learning based on a contrastive loss for negative and positive pairs of samples constructed from the training data, or on a self-supervised learning method employing a redundancy reduction loss.

In further features, the method further includes: by a prediction module, during the pre-training, generating second matrix representations based on the samples, respectively, where the pre-training includes pre-training the artificial neural network and the prediction module based on minimizing a similarity loss determined based on the matrix representations and the second matrix representations.

In further features, the artificial neural network is trained to perform one of an image classification task and an image regression task.

In a feature, a system includes: an artificial neural network including an encoder module and a projection module configured to generate matrix representations based on input samples; training data including samples and corresponding labels; and a training module configured to: pre-train the artificial neural network to generate matrix representations that are invariant to a predetermined set of data augmentations applied to a sample; and after the pre-training, fine-tune train the artificial neural network using a loss function, the fine-tune training including adjusting, based on the labels, one or more weights of the projection module while maintaining constant weights of the encoder module, where the loss function is based on a logit adjustment loss that is based on logits that are adjusted based on a class distribution of the training data.

In further features, the method further includes the samples are image samples, and wherein the data augmentations are image transformations.

In a feature, a method for performing a task using an artificial neural network fine-tune trained with training data including data samples and corresponding labels is described and includes: receiving an image by the artificial neural network configured to perform a task based on received images, the artificial neural network including an encoder module followed by a projection module and configured to generate matrix representations based on input samples; and processing the image using the artificial neural network to perform the task, where the artificial neural network is pre-trained to generate matrix representations that are invariant to a predetermined set of data augmentations applied to received images, and where the artificial neural network is, after the pre-training, fine-tune trained using a loss function, the fine-tune training including adjusting, based on the labels, one or more weights of the projection module while maintaining constant weights of the encoder module, where the loss function is based on a logit adjustment loss that is based on logits that are adjusted based on a class distribution of the training data.

In further features, the task is one of image classification and image regression.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a schematic of an example embodiment for pre-training an artificial neural network for learning from noisy and unbalanced data;

FIG. 1B is a schematic of an example embodiment for pre-training an artificial neural network for learning from noisy and unbalanced data;

FIG. 2 is a schematic for fine-tuning an artificial neural network on noisy and unbalanced data according to an embodiment;

FIG. 3 displays accuracy gain at different noise levels achieved by embodiments on datasets with different methods;

FIG. 4 shows accuracy at different noise levels on datasets and different imbalance ratios achieved by two-stage training as compared with single stage training;

FIG. 5 shows accuracy at different noise levels on datasets and different imbalance ratios achieved;

FIG. 6 shows results for accuracy on the Clothing-1M dataset in dependence on training epochs;

FIG. 7 shows a bar chart of accuracy on the Clothing1M dataset;

FIG. 8 illustrates t-SNE projections of results obtained on a dataset;

FIG. 9 illustrates t-SNE projections of results obtained on a dataset; and

FIG. 10 illustrates an example architecture in which the disclosed systems methods may be implemented.

In the drawings, reference numbers may be reused to identify similar and/or identical elements.

### DETAILED DESCRIPTION

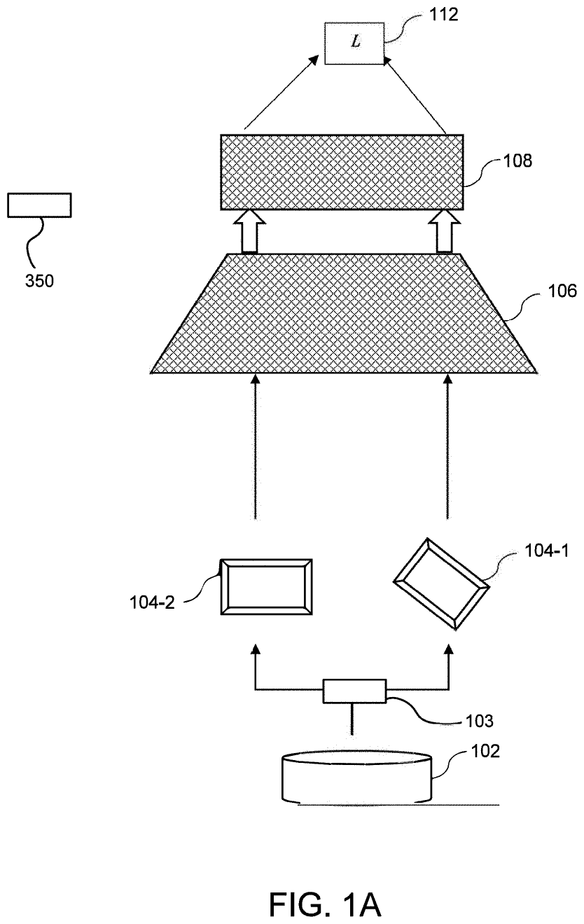

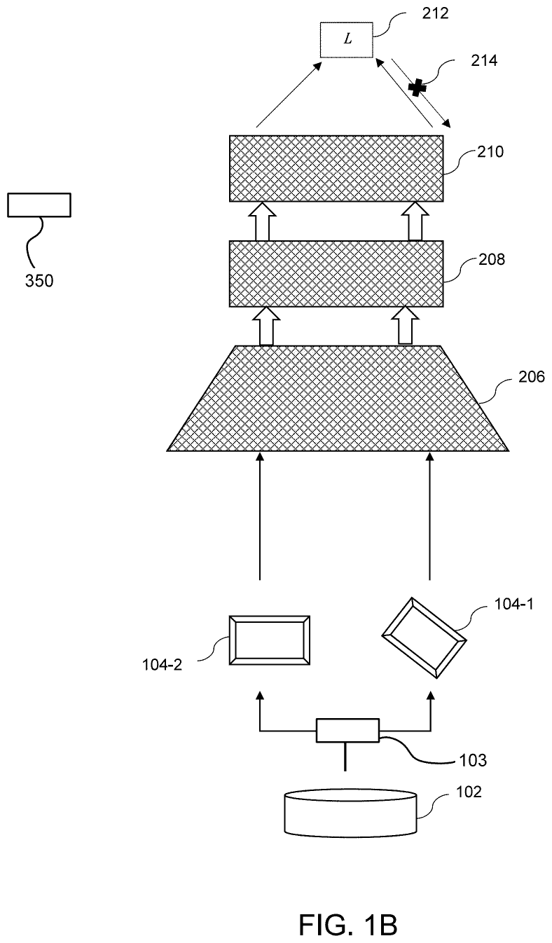

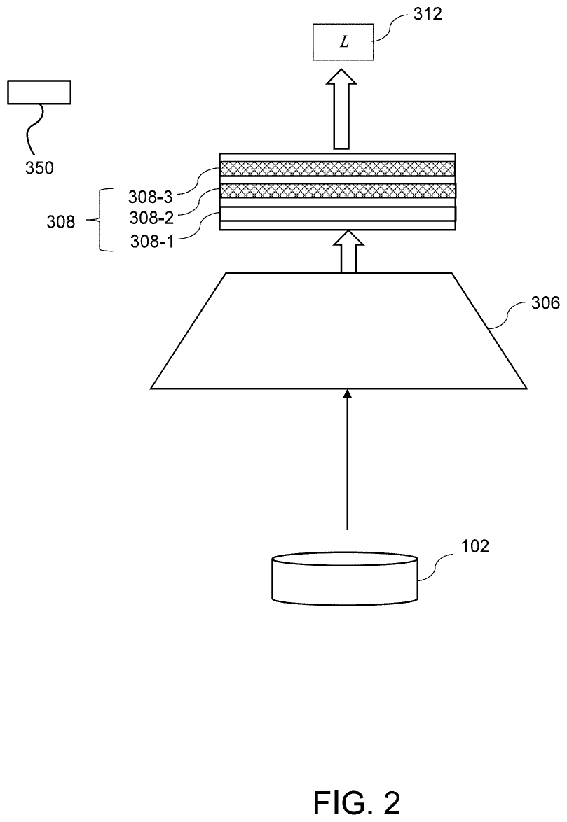

Described herein is a machine learning approach that is based on task-agnostic pre-training (for representation generation), which will be described with reference to FIG. 1A and FIG. 1B, and task-specific fine-tuning, which will be described with reference to FIG. 2 (for image classification). A set of data items 102 includes data items (samples) that are each annotated with a label so as to train an artificial neural network (module), such as for image regression and/or image classification. The present application allows learning accurate predictors even in the presence of significant label noise (e.g., more than half of the samples). Label noise may refer to the situation where the label associated with a sample is not reflective of the sample, such when an image of a pear is labeled as an apple instead of a pear. Noisy samples may refer to samples that are annotated incorrectly (e.g., manually or automatically). For example, image including a cat having an annotation of “dog” is an example of a noisy sample. Long tailed data may refer to a statistical distribution of the data. For example, in image classification, high frequency classes may be followed by lower frequency classes, which “tail off” asymptotically. Events/classifications at the far end of the tail (where the data is “tailing off”) have a very low probability. For example, street view images may have a high probability of including a vehicle or a tree, but a very low probability of including a whale or a shark.

Pre-training according to FIG. 1A and FIG. 1B is based on a self-supervised learning approach. Self-supervised learning of representations may be based on a Siamese network architecture, where the neural network is trained for invariance to random data augmentations. This approach may collapse to trivial solutions. The pretraining of FIGS. 1A and 1B are train an encoder to generate representations of inputs (e.g., images).

To address this problem and avoid collapsing, different strategies are disclosed herein. Some approaches use negative samples and contrastive losses based on artificially constructing positive and negative pairs from the training data. Other approaches employ momentum contrast.

Yet other approaches are based on trainable versions of the K-means clustering method to learn clustering stable against random argumentation. One approach overcomes the problem of collapse by proposing a specific loss function which involves a term for redundancy reduction.

In the embodiment of FIG. 1A, an artificial neural network includes a pipeline of an encoder (module) 106 and a projection head (module) 108. As an example, the encoder 106 may be or include a ResNet encoder, such as the ResNet-50 encoder or another suitable type of encoder. In an embodiment, the first convolutional layer of the ResNet encoder may have a stride of 3×3 and not include the first max pooling layer of the ResNet encoder. The projection module 108 may include two or three fully-connected layers.

During pre-training, labels of the data items (samples) from a data store 102 are ignored. Each data item is processed (e.g., augmented) by a data augmentation module 103 to produce first augmented data item 104-1 and second augmented data item 104-2. The data augmentations producing augmented data items 104-1, 104-2 are selected by the data augmentation module 103 independently of each other from a set of data augmentation operations. When the data items are image data items, the set of data augmentation operations are image transformations including, for example, scaling operations, color jitter operations, blur operations, and rotation operations, and other types of image transformations. The image transformations may also include cropping (e.g., random) followed by resizing back to the original size. The blur operation may include a Gaussian blur (e.g., random) operation or another suitable type of blurring.

The encoder 106 and the projection head 108 are trained to generate representations (e.g., matrices) based on the augmented data items 104-1, 104-2. During training, weights of the artificial neural networks of the encoder 106 and the projection head 108 are adjusted, which is indicated in FIG. 1A by the respective areas being drawn hatched, to minimize a loss 112 calculated between the respective representations produced based on the augmented data item 104-1 and augmented data item 104-2 by the encoder 106 and the projection head 108. In various implementations, the loss 112 may be a contrastive loss or another suitable type of loss.

In a mini-batch of n data items, resulting in 2n augmented data items, given a positive (matching) pair of data items, the other 2(n−1) augmented data items within the mini-batch are treated as negative (not matching) examples. The loss function 112 [symbol] _{CLR} may be a sum of pairwise elements l_{i,j}. For a positive pair of examples (i, j), the pairwise element may be defined as:

$${l}_{i , j} = - log ( \frac{exp ( \frac{sim ( {z}_{i} , {z}_{j} )}{τ} )}{{\sum }_{k = 1 , k \neq i}^{2 N} exp ( \frac{s i m ( {z}_{i} , {z}_{k} )}{τ} )} ) . \qquad ( 1 )$$

In various implementations, the loss may be as used in Barlow Twins, Zbontar et al., Barlow twins: Self-supervised learning via redundancy reduction, arXiv: 2103.03230, 2021, which is incorporated herein in its entirety. The loss function in this case may be described by

$${ℒ}_{B T} = {\sum }_{i} {( 1 - {C}_{i , i} )}^{2} + λ {\sum }_{i} {\sum }_{j \neq i} {C}_{i , j}^{2} , \qquad ( 2 )$$

where C is the cross-correlation matrix computed between outputs of the two identical networks along the batch dimension. The encoder 106 and the projection head 108 adjust their respective weights during the training, such as to minimize the loss 112.

FIG. 1B includes an example embodiment for pre-training the artificial neural network for learning on noisy and imbalanced training data. Similarly, as described with respect to FIG. 1A, FIG. 1B includes an encoder (module) 206 and projection head (module) 208 receiving augmented data item 104-1 and augmented data item 104-2 that are obtained from applying data augmentations selected from a set of data augmentations to a data item from the data store 102, as discussed above. In the example of FIG. 1B outputs of the projection head 208 are transmitted to a prediction head (module) 210 that determines representations for augmented data items 104-1, 104-2 that are compared to the outputs of the projection head 208 determine a similarity loss 212. The projection head 208 determines its output representations based on the representations, respectively, from the projection head 208.

In the example of FIG. 1B, one of the training paths includes a stop-loss 214 which defines a stop gradient operation so that the representation of augmented data item 104-1 is treated as constant during gradient descent. During pre-training in the example of FIG. 1B, weights of the encoder 206, the projection head 208, and the prediction head 210 are adjusted, which is indicated in FIG. 1B by the respective areas being drawn hatched. In other words, the encoder 206, the projection head 208, and the prediction head 210 adjust their respective weights during the training, such as to minimize the loss 212.

The loss function [symbol] 212 employed may be symmetric with respect to the augmented data items 104-1, 104-2, and may specifically read

[symbol]

=½ [symbol] (p₁,stopgrad(z₂))+½ [symbol] (p₂,stopgrad(z₁)), (3)

where [symbol] denotes the cosine similarity, p₁, p₂ are representations generated by the projection head 208 from the data items 104-1, 104-2, respectively, and z₁, z₂ are representations generated by prediction head 210 from the representations p₁, p₂, respectively. The stop gradient operation may imply that the encoder 206 receives no gradient from the representations z₁ and z₂.

In an example, pre-training according to FIG. 2 is based on BYOL, as described in Grill et al., Bootstrap your own latent—A new approach to self-supervised learning, in: Adv. Neural Inform. Process. Syst., 400 2020, which is incorporated herein in its entirety. The pretraining in this example includes use of a loss function analogous to Equation (3). The two branches of the encoder 206 and the projection head 208 are treated asymmetrically, so that one of the branches is updated according to the loss function, whereas the other branch is updated according to a momentum loss. For fine-tuning, only the encoder 206 and the projection head 208 are used.

FIG. 2 involves fine-tuning the projection head 308 for classification in some examples. While the pre-training stage may be task-agnostic, fine-tuning trains the pre-trained network with the labels of the noisy and unbalanced training data. During fine-tuning portion of the training, data items from the data store 102 are provided to an encoder (module) 306 (106, 206) and a projection head (module) 308 that has been pre-trained as the projection head 108 or 208 as explained above with reference to FIG. 1A and FIG. 1B.

During the fine-tuning, only weights of the projection head 308 are selectively adjusted, not weights of the encoder 306. In some examples, only a subset of the layers of the projection head 308 are adjusted. In these examples, the layers of the projection head 308 may be adjusted from a middle layer. In various implementations, the projection head 308 includes layers 308-1, 308-2, and 308-3. For example, middle layer 308-2 and final layer 308-3 of the projection head may be trained while layer 308-1 is kept constant, as is indicated in FIG. 2 by the areas of layers 308-2 and 308-3 being drawn hatched while layer 308-1 and encoder 306 are not drawn hatched. In various implementations, a training module 350 may be used to perform the training described herein.

In various implementations, such as when a noise level of the data items is high (e.g., greater than a predetermined noise value), it may be advantageous to only adjust the final layer of the projection head 308, for example, layer 308-3, while layers 308-1 and 308-2 are kept constant.

A loss function 312 used and minimized for fine-tuning may be a logit adjustment loss that is adjusted for robustness against both label noise and class imbalance. To form the logit adjustment loss, for f(x)=w_{y}^{T}Φ(x), where w_{y} are classification weights and Φ(x) is a representation of a neural network f(x) which is a vector of logits (e.g., values derived from a probability over an observed class distribution) adjusted based on the observed class distribution π_{y} to define f_{y}*(x) as:

f_{y}*(x)=f(x)+log π_{y}. (4)

In various implementations, π_{y} is determined by analyzing the training data. The logit adjustment loss may be based on employing the adjusted f_{y}*(x) in a softmax cross-entropy loss. The logit adjustment loss is hence:

$${ℒ}_{L A} = - log ( \frac{exp {f}_{y}^{*} ( x )}{{\sum }_{{y}^{′}} exp {f}_{{y}^{′}}^{*} ( x )} ) . \qquad ( 5 )$$

This loss function hence applies a label-dependent offset to each logit directly during training, rather than applying a post-hoc adjustment. Given a neural network that minimizes the loss of equation (3), a prediction according to argmax_{y}f(x) is determined. f(x) is a vector, and the values of the vector for class y is denoted f_y(x).

In various implementations, fine-tuning training is performed based on a confidence-aware loss function that is translation-invariant, homogeneous, and satisfies a generalization criterion. A confidence-aware loss function termed SuperLoss satisfying these criteria may be described by:

[symbol]

_{LA+SL}=( [symbol] _{LA}−τ)σ*+λ(log σ*)², (6)

where τ defines a threshold parameter separating data items that are simple to classify from data items that are difficult to classify, λ is a regularization tradeoff, and σ* is a per-sample confidence parameter,

$${σ}^{*} = exp [ - W ( \frac{1}{2} max ( \frac{{ℒ}_{L A} - τ}{λ} , \frac{2}{e} ) ) ] , \qquad ( 7 )$$

where W is the Lambert function. An example of such a confidence-aware loss function is described in Castells et al., Superloss: A generic loss for robust curriculum learning, in: Adv. Neural Inform. Process. Syst., volume 33, 2020, which is incorporated herein in its entirety.

The effect of the loss of equation (6) is down-weighing contributions of hard data items (e.g., those data items having a higher loss value so that the training effect of noisy labels is reduced over the correct labels).

In various implementations, the SuperLoss ( [symbol] _{SL}) may be applied on top of a cross-entropy loss [symbol] _{CE} and described by the equation

[symbol]

_{SL}=( [symbol] _{CE}−τ)σ′+λ(log σ′)², (8)

where the cross-entropy loss is described by

$${ℒ}_{C E} = - log ( \frac{exp {f}_{y} ( x )}{{\sum }_{{y}^{′}} exp {f}_{{y}^{′}} ( x )} ) , \qquad ( 9 )$$

and, in analogy to equation (7),

$${σ}^{′} = exp [ - W ( \frac{1}{2} max ( \frac{{ℒ}_{C E} - τ}{λ} , \frac{2}{e} ) ) ] . \qquad ( 10 )$$

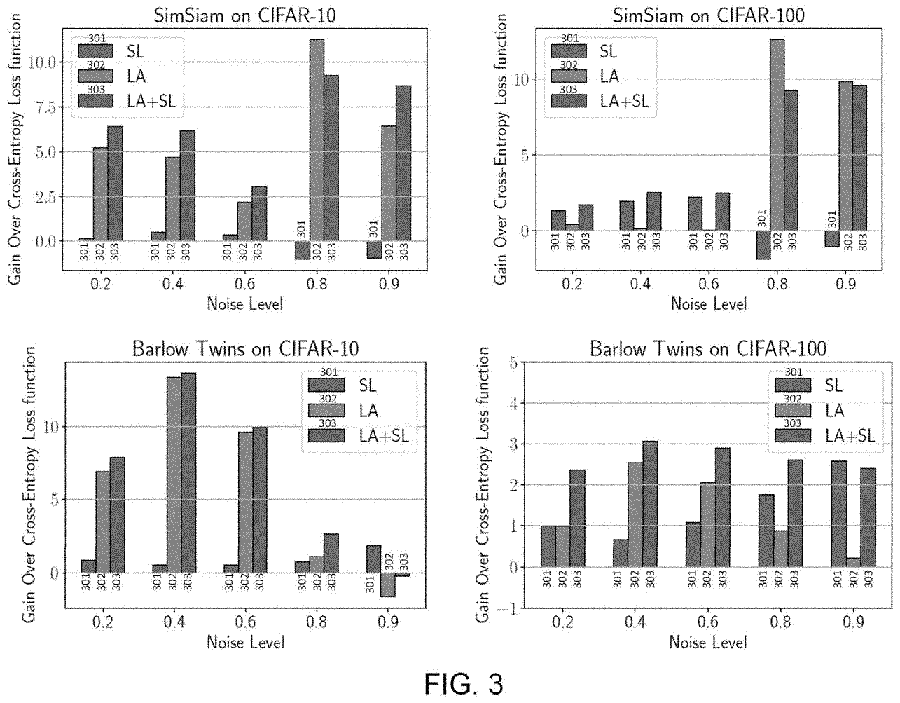

In various implementations, the variable τ is an expected loss for an average data item, and fine-tuning the artificial neural network performed according to FIG. 3 includes adjusting the parameter T to correspond to the average loss of data items observed in the data items from the data store 102 so far processed.

In various implementations, fine-tuning according to FIG. 2 trains the artificial neural network to classify images. In other embodiments, fine-tuning according to FIG. 2 trains the artificial neural network for regression on images, such as estimating a pose of a human pictured in the image.

To demonstrate capabilities of the training described herein, results achieved by embodiments based on other approaches are provided. To allow systematic study of the effect of imbalance, the data sets (e.g., CIFAR-10 and CIFAR-100) may be pruned to create imbalanced versions by down-sampling the number of samples per class, such as to follow an exponential profile. Further, label noise at a defined noise frequency may be added by randomly switching labels.

Example training may be for 1000 epochs using the Adam Optimizer with a learning rate of 10-3, weight decay of 10-6, and batch size of 512. For fine-tuning, a linear classifier (e.g., 210) may be trained based on the representations extracted by the encoder. The classifier may be trained for 25 epochs using the Adam Optimizer with same learning rate and weight decay as used in pre-training.

In various implementations, two fully-connected layers may be used (e.g., in 308) instead of three, which may provide better results. The artificial neural network may be trained for 800 epochs using stochastic gradient descent with base Ir=0.03 and batch size bs=512, so that the learning rate is Ir×bs/256. Weight decay may be set to 5·10⁻⁴, and the momentum of stochastic gradient descent may be set to 0.9. For fine-tuning, the projection head with two fully-connected layers may be trained for 10 epochs with the Adam Optimizer and a learning rate of 3·10⁻³ without weight decay and a batch size of 256. In examples where noise level of the data items is greater than or equal to 60% only the last fully-connected layer may be fine-tuned with, for example, a 10⁻² learning rate.

In implementations based on BYOL, the same pre-training may be employed with base learning rate set to 10⁻³ and weight decay of 1.5×10⁻⁶. At noise levels of greater than or equal to 40%, only one fully connected layer (e.g., last fully-connected layer) may be fine-tuned.

In implementations based on Barlow Twins, the pre-training may be the same, such as with a base learning rate 3·10⁻³. The A parameter may be kept to 5·10⁻³ but the size of the hidden layer and output layers of the projection head may be set to 2,048, such as for better performance. At noise levels of greater than or equal to 20% only one of the fully-connected layers (e.g., last fully-connected layer) of the projection head may be fine-tuned.

FIG. 3 illustrates absolute improvement of accuracy compared to models fine-tuned employing a cross-entropy loss. FIG. 3 shows results for models based on different approaches in the top row and the bottom row each for the CIFAR-10 dataset (left column) and the CIFAR-100 dataset (right column). The left bars 301 show results for employing a SuperLoss SL, the middle bars 302 show results for logit adjustment LA, and the right bars 303 show results for employing the combination LA+SL. The case SL employs SuperLoss on top of a cross-entropy loss according to Equations (8)-(10).

In FIG. 3, the reported results are averaged over all imbalance ratios γ=50, 100 for CIFAR-10, and γ=5, 10 for CIFAR-100. The parameter T of the SuperLoss may be set to a log(C), where C is the number of classes (i.e., 10 for the CIFAR-10 dataset and 100 for the CIFAR-100 dataset). As can be inferred from FIG. 3, the accuracy gain achieved by combining logit adjustment and the SuperLoss can be greater than 10%. A comparison of models based on other approaches yields similar results.

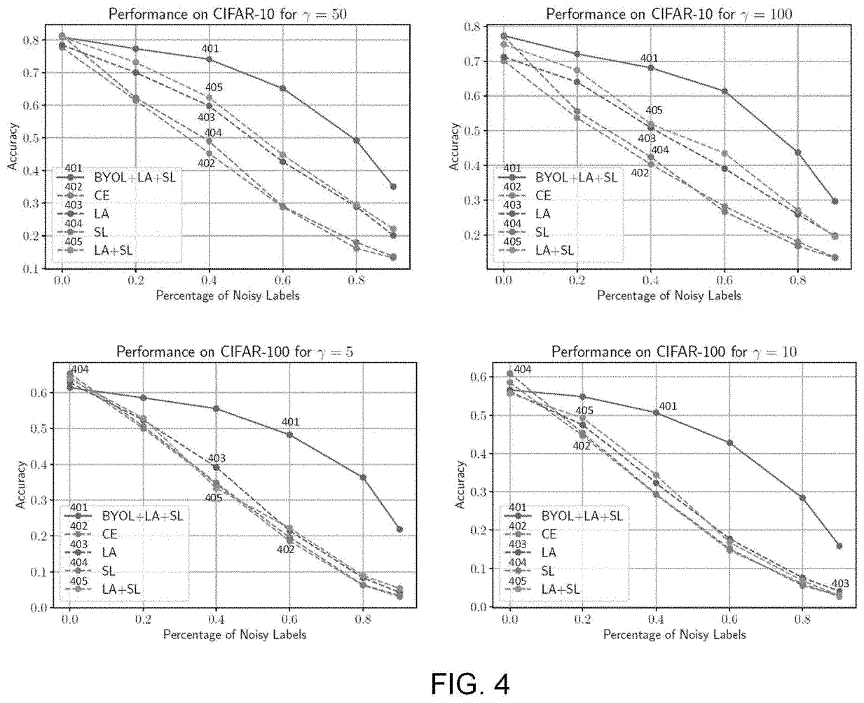

FIG. 4 illustrates a comparison between artificial neural networks trained in a single-stage and two-stage using BYOL. The results of FIG. 4 correspond to ablation of two-stage training. The single-stage training employs the loss LA+SL according to Equations (5)-(7), LA according to Equation (5), and SL alone according to Equations (8)-(10). The two-stage training employs BYOL and the loss LA+SL.

In the top left and top right panels, at a noise level of 40%, BYOL+LA+SL 401 achieves a better accuracy than LA+SL 405, LA 403, SL 404, and CE 402, which are listed in order of decreasing accuracy. In the bottom left panel, at a 60% noise level, BYOL+LA+SL 401 achieves a better accuracy than LA+SL 405, LA 403, SL 404, CE 402, which are listed in order of decreasing accuracy. In the bottom right panel, at a 0% noise level, SL 404 achieves a greater accuracy than CE 402, BYOL+LA+SL 401, LA 403, and LA+SL 405, which are listed in order of decreasing accuracy. Above a noise level of 20% BYOL+LA+SL achieves better accuracy than the other approaches.

As can be seen from FIG. 4, in the absence of noise, single-stage training may be as accurate or more accurate than two-stage training. With label noise, however, two-stage training is more accurate than single stage training, even at a low noise level of 20%. Two-stage training involves only little more effort than single-stage training because fine-tuning is performed only over a minimal number of epochs and updates only a few layers.

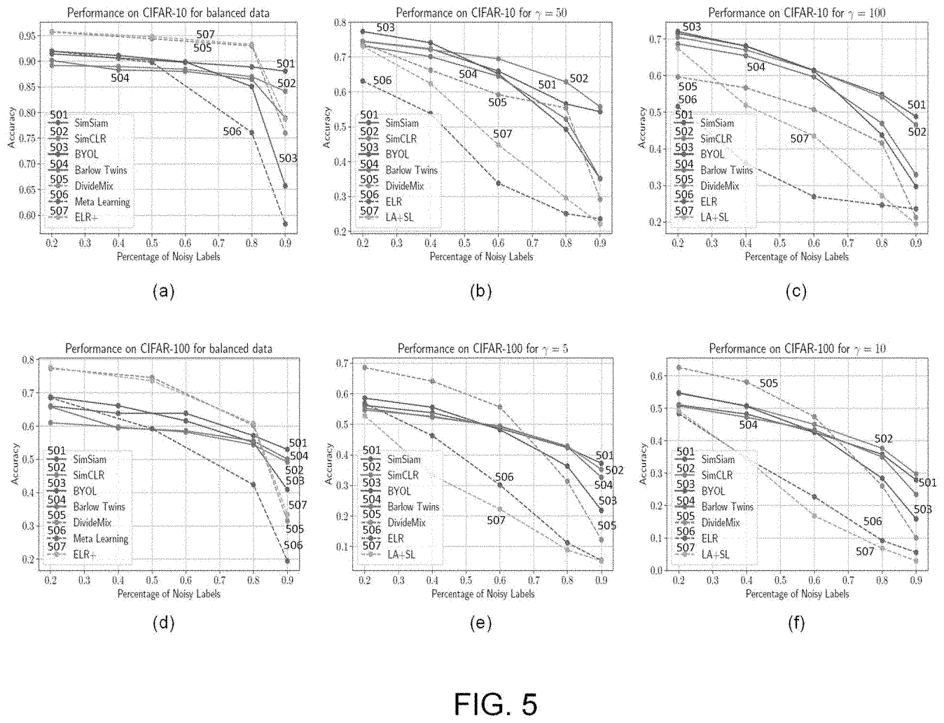

In FIG. 5, different embodiments trained on the CIFAR-10 dataset, (a) to (c), and the CIFAR-100 dataset, (d) to (f), are displayed. Shown are results for embodiments based on SimSiam, SimCLR, BYOL, and BarlowTwins approaches. For comparison, the results for approaches DivideMix an ELR approaches are displayed, which are both designed to have robustness to label noise. DivideMix is described in Li et al., “Dividemix: Learning with noisy labels as semi-supervised learning”, in: Int. Conf. Learn. Represent., 2020, and ELR is described in Liu et al., “Early-learning regularization prevents memorization of noisy labels”, in: Adv. Neural Inform. Process. Syst., 2020.

As is evident, DivideMix and ELR do not achieve good accuracy when the noise level is greater than a predetermined value. For instance, self-supervised models start outperforming DivideMix on the CIFAR-100 dataset at γ=5 when the noise level is above 70%. More generally, the performance of the self-supervised models degrades much less, even when the noise is increased to 80% or 90%. Further, embodiments employing BYOL outperform other approaches in low to moderate noise level, but may underperform at high noise levels. Embodiments employing SimSiam may be similar to BYOL however are either on par or better than other self-supervised approaches under high amounts of noise. SimSiam is described in Chen and He, Exploring Simple Siamese Representation Learning, arXiv: 2011.10566, 2020, which is incorporated herein in its entirety.

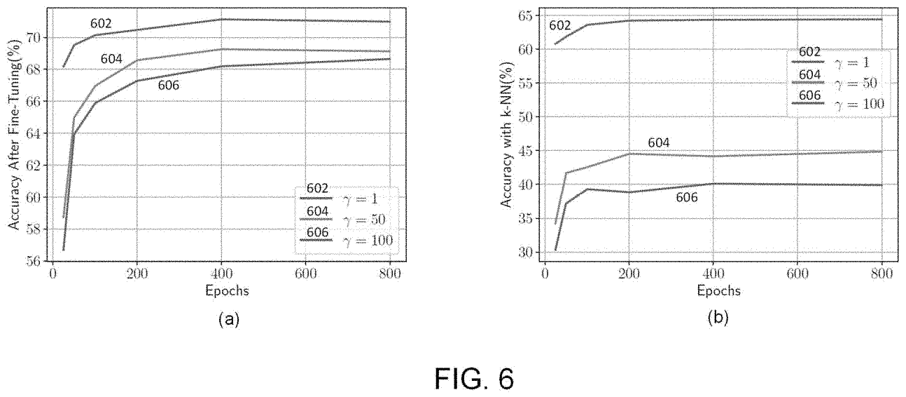

FIG. 6 shows results for artificial neural networks trained in the Clothing1M dataset. In (a) the accuracy after fine-tuning is reproduced, in (b) a kNN-based proxy metric proposed by Chen et al 2011, “Exploring Simple Siamese Representation Learning”, arXiv:2011.10566, 389 2020 is shown. In both (a) and (b) γ=1 is the topmost line, while γ=50 and γ=100 are the middle and lower line.

In imbalanced settings, the metric correlates weakly with the much higher performance obtained after the fine-tuning. In contrast to the kNN-based accuracy that stagnates, the actual accuracy after fine-tuning may keep increasing after 200 epochs, even though accuracy eventually gradually diminishes, which is expected.

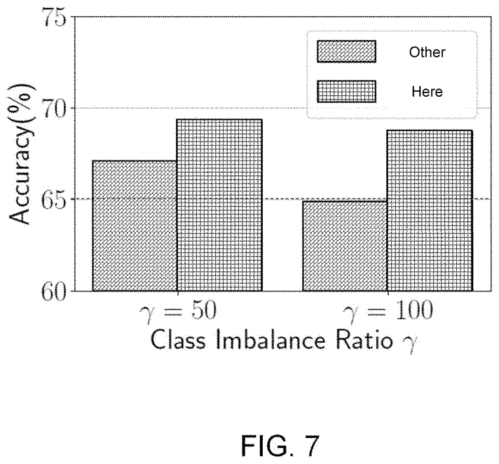

FIG. 7 shows a bar chart of summed accuracy results for embodiments trained on the Clothing-1M dataset when the training set is severely imbalanced. “Other” represents another approach, while “here” represents an artificial neural network as described herein.

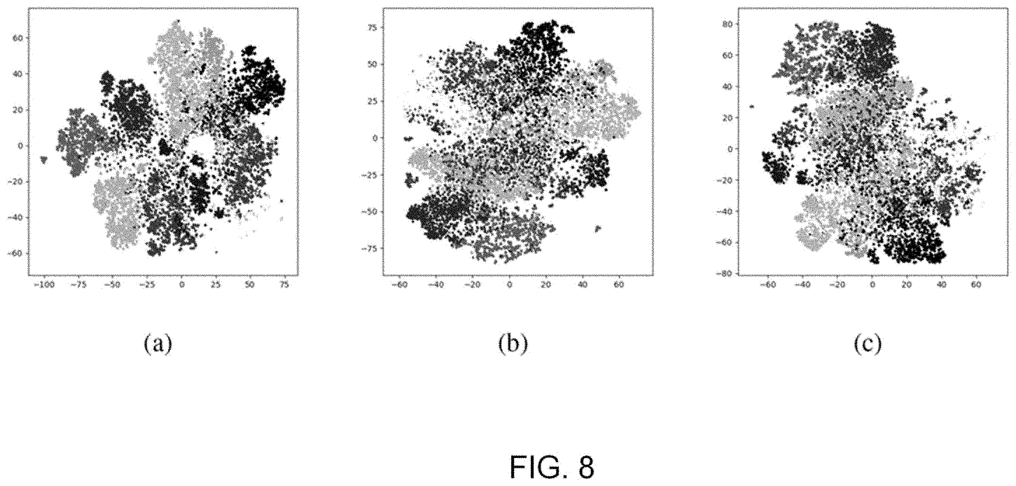

FIG. 8 shows a high quality of representations learned via self-supervision in spite of highly unbalanced class distributions. In (a)-(c) t-SNE projections of an embodiment employed on the CIFAR-10 dataset with varying imbalance ratio are displayed. Even severe class imbalance shows little impact on the separability of classifications. FIG. 8, panels (b) and (c) illustrate that the erosion of small class boundaries may be limited compared to the balanced (classification) case.

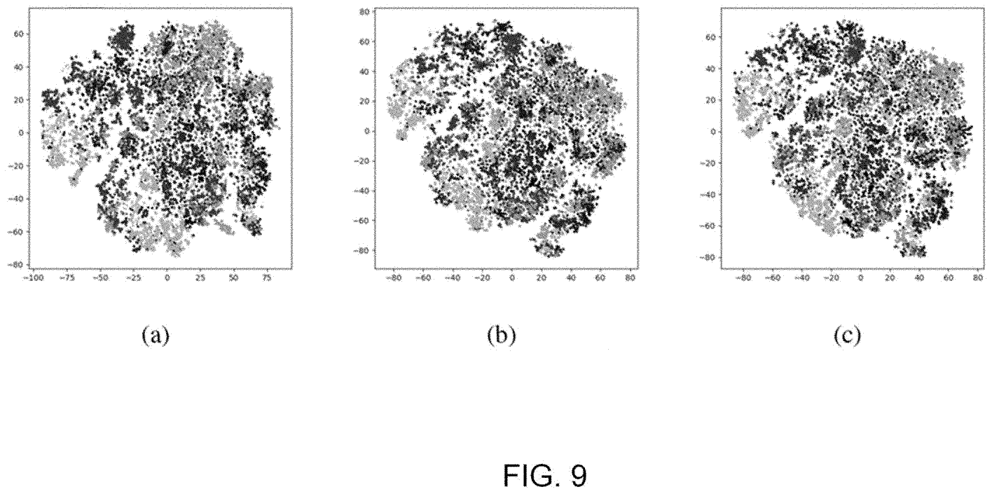

FIG. 9 shows corresponding t-SNE projections of representations generated as discussed herein training on the Clothing-1M dataset for different imbalance levels. For this dataset, classes may be harder to separate in general, as compared to the CIFAR-10 dataset. However, FIG. 9 also shows that in this case severe class imbalance has little impact on the separability of classes for training approaches according to the here disclosed embodiments.

TABLE 1

| Method | γ = 1 | γ = 50 | γ = 100 |
|---|---|---|---|
| DivideMix | 73.9 | 67.1 | 64.9 |
| ELR | 74.2 | 63.9 | 59.6 |
| SimSiam + LA + SL | 71.1 | 69.3 | 68.2 |

Table 1 reproduces results for training on the Clothing-1M dataset with varying imbalance of an embodiment based on SimSiam, logit adjustment, and SuperLoss as compared with training according to DivideMix and ELR. DivideMix and ELR use ImageNet initialization and model ensembling, which significantly contribute to their performance, whereas the SimSiam-based model, trained from scratch and without such complex approaches performs almost as well. Performance of DivideMix and ELR may degrade when imbalance is introduced. The SimSiam-based embodiment yields similar performance regardless of the imbalance level.

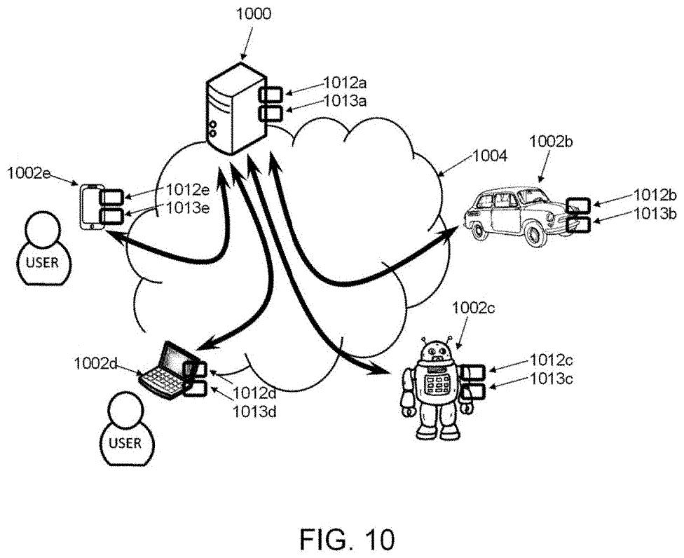

The above-mentioned systems, methods and embodiments may be implemented within an architecture such as that illustrated in FIG. 10, which comprises server 1000 and one or more computing devices 1002 that communicate over a network 1004 (which may be wireless and/or wired), such as the Internet, for data exchange. The server 1000 and the client devices 1002 each include one or more processors 1012 and memory 1013, such as a hard disk.

The computing devices 1002 may be any type of computing devices that communicate with the server 1000, including, but not limited to, an autonomous vehicle 1002b, a robot 1002c, a computer 1002d, or a cell phone 1002e. The machine learning system according to the embodiments of FIGS. 1A, 1B and 2 may be implemented on the server 1000. The trained machine learning system may be stored and executed from the memory 1013a.

In various implementations, the autonomous vehicle 1002b may store in the memory 1013b weights of the artificial neural network fine-tuned and pre-trained by server 1000 as described with reference to FIG. 1A or FIG. 1B and fine-tuned as described with reference to FIG. 2. The artificial neural network may be fine-tuned for object classification to allow the autonomous vehicle 1002b to infer information about its environment based on images captured by one or more cameras of the autonomous vehicle 1002b.

As another example, the artificial neural network may be fine-tuned for human pose detection to allow the robot 1002c to infer information about its environment based on images captured by one or more cameras of the robot 100c. Leveraging methods of this disclosure allows reducing expense for yielding training data employed to train the artificial neural network. Further, data collected by the autonomous vehicle 1002b or robot 1002c having noisy labels can be sent by the autonomous vehicle 1002b or the robot 1002c to the server 1000 to allow further fine-tuning of the artificial neural network. Some or all of the method described above may be implemented by a computer in that they are executed by (or using) a processor, a microprocessor, an electronic circuit or processing circuitry.

The foregoing description is merely illustrative in nature and is in no way intended to limit the disclosure, its application, or uses, which includes localization tasks, semantic segmentation tasks, depth estimation tasks, image retrieval tasks, image classification (i.e., target variable is not continuous) tasks, and image regression (i.e., target variable is continuous) tasks with natural class imbalance where labeling/annotation noise may be introduced via querying, tags, metadata extraction, crowdsourcing, and other tasks. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for training an artificial neural network with training data including samples and corresponding labels for performing a task, the method comprising:
pre-training the artificial neural network to generate matrix representations that are invariant to a predetermined set of data augmentations applied to a sample,
wherein the artificial neural network includes an encoder module and a projection module configured to generate the matrix representations based on ones of the samples, respectively; and
after the pre-training, fine-tune training the artificial neural network using a loss function, wherein fine-tuning the artificial neural network includes adjusting, based on the labels, one or more weights of the projection module while maintaining constant weights of the encoder module, and
wherein the loss function is based on a logit adjustment loss that is based on logits that are adjusted based on a class distribution of the training data.

2. The method of claim 1, further comprising curriculum learning based on a difference between the logit adjustment loss and a separation parameter defining an expected logit adjustment loss,
wherein the loss function includes a term including a predetermined per-sample confidence parameter.

3. The method of claim 2, further comprising determining the separation parameter as a running average of the logit adjustment loss.

4. The method of claim 1, wherein the logit adjustment loss is determined based on a softmax over the logits that are adjusted based on the class distribution.

5. The method of claim 1, further comprising, before fine-tune training the artificial neural network, estimating the class distribution.

6. The method of claim 1, wherein the class distribution of the labels over the samples is a long-tailed class distribution.

7. The method of claim 1 wherein the labels are noisy.

8. The method of claim 1 wherein the projection module includes two or more fully-connected layers, wherein adjusting one or more of the weights of the projection module includes adjusting one or more of the weights of at least one of the two or more fully-connected layers.

9. The method of claim 8, wherein the projection module includes three fully-connected layers, and
wherein adjusting one or one or more weights of includes:
adjusting one or more weights of a middle layer of the three fully-connected layers while maintaining constant weights of the other ones of the three fully-connected layers.

10. The method of claim 8, wherein the projection module includes two fully-connected layers, and
wherein, when a noise level of the labels is greater than a predetermined value, adjusting one or more of the weights includes adjusting one or more of the weights of only the last one of the two fully-connected layers and maintaining constant weights of first and middle ones of the two fully-connected layers.

11. The method of claim 1, wherein the pre-training includes optimizing a loss between respective representations generated by the artificial neural network for a first augmented data sample and a second augmented data sample,
wherein the first and second augmented samples are generated by the artificial neural network by applying first and second data augmentations of the set of predetermined data augmentations, respectively, to the sample.

12. The method of claim 1, wherein the samples are image samples, and wherein the data augmentations are image transformations.

13. The method of claim 1 further comprising, by the artificial neural network, classifying an object in an image after the fine-tune training.

14. The method of claim 1 further comprising, by the artificial neural network, performing image regression after the fine-tune training.

15. The method of claim 1, wherein the pre-training includes self-supervised learning based on a contrastive loss for negative and positive pairs of samples constructed from the training data, or on a self-supervised learning method employing a redundancy reduction loss.

16. The method of claim 1 further comprising:
by a prediction module, during the pre-training, generating second matrix representations based on the samples, respectively,
wherein the pre-training includes pre-training the artificial neural network and the prediction module based on minimizing a similarity loss determined based on the matrix representations and the second matrix representations.

17. The method of claim 1 wherein the artificial neural network is trained to perform one of an image classification task and an image regression task.

18. A system, comprising:
an artificial neural network including an encoder module and a projection module configured to generate matrix representations based on input samples;
training data including samples and corresponding labels; and
a training module configured to:
pre-train the artificial neural network to generate matrix representations that are invariant to a predetermined set of data augmentations applied to a sample; and
after the pre-training, fine-tune train the artificial neural network using a loss function, the fine-tune training including adjusting, based on the labels, one or more weights of the projection module while maintaining constant weights of the encoder module,
wherein the loss function is based on a logit adjustment loss that is based on logits that are adjusted based on a class distribution of the training data.

19. The system of claim 18 wherein the samples are image samples, and wherein the data augmentations are image transformations.

20. A method for performing a task using an artificial neural network fine-tune trained with training data including data samples and corresponding labels, the method comprising:
receiving an image by the artificial neural network configured to perform a task based on received images, the artificial neural network including an encoder module followed by a projection module and configured to generate matrix representations based on input samples; and
processing the image using the artificial neural network to perform the task,
wherein the artificial neural network is pre-trained to generate matrix representations that are invariant to a predetermined set of data augmentations applied to received images, and
wherein the artificial neural network is, after the pre-training, fine-tune trained using a loss function, the fine-tune training including adjusting, based on the labels, one or more weights of the projection module while maintaining constant weights of the encoder module,
wherein the loss function is based on a logit adjustment loss that is based on logits that are adjusted based on a class distribution of the training data.

21. The method of claim 20 wherein the task is one of image classification and image regression.
